(19) United States
(12) Patent Application Publication
(10) Pub. No.: US 2010/0036775 A1
(43) Pub. Date: Feb. 11, 2010

(54) FOREIGN CURRENCY GAIN/LOSS ANALYSIS FOR FOREIGN CURRENCY EXPOSURE MANAGEMENT

(76) Inventor: Corey D. Edens, Scottsdale, AZ (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/188,928

(22) Filed: Aug. 8, 2008

(51) Int. Cl. G06Q 40/00

(52) U.S. Cl. 705/36 R; 705/35

(57) ABSTRACT

Tools for analysis of foreign currency gain/loss are described. An analysis tool obtains multicurrency accounting data from one or more systems. Based on a selected exposure period, exchange rates for the exposure period, and the obtained accounting data, the analysis tool can compute an expected foreign currency gain or loss for the exposure period. Exposure for the beginning and ending of the exposure period are computed, and can be compared to generate a delta exposure for the exposure period. The analysis tool then generates an expected foreign currency gain and/or loss for the exposure period, and reports the expected gain/loss. The report indicates actual foreign currency gain/loss balances from accounting records for the exposure period compared to calculated expected foreign currency gain/loss for analysis. Material exceptions between the actual balance and calculated expected balance can be isolated for further investigation to test multicurrency accounting practices in place within the enterprise.

### FIELD

Embodiments of the invention relate to foreign currency exposure management, and more particularly to tools to analyze foreign currency gain or loss for an exposure period.

### BACKGROUND

Companies record business transactions in their ERP (enterprise resource planning) and accounting systems each and every business day, including sale of products, purchase of materials or services, and accruals and adjustments. As companies expand internationally, they most likely will enter into business transactions that are denominated in a currency that is foreign, or different than the reporting currency of the company. The reporting currency refers to the currency in which records and reports of the company are designated. The value of business transactions denominated in different currencies changes in relation to the reporting currency of the company each and every business day as the exchange rate between the two currencies fluctuates with the movement of the interbank foreign currency market. As an example, assume a company that has U.S. dollar as its reporting currency (“USD company”) has sold its product to a European manufacturer and denominated the sale in EUR (Euros) and given the customer 60 day payment terms. The company now has a EUR account receivable in its general ledger (G/L) accounts. For purposes of example, consider the value of the account receivable to be EUR 1 million. If at the time of sale the EUR-USD exchange rate was 1.5700, the USD value of the account receivable was $1,570,000. As the interbank foreign exchange rate market changes each second of every business day around the world, the USD value of this account receivable started to change the second after the transaction was recorded in its general ledger. Assume the EUR-USD exchange rate moved from 1.5700 to 1.5350 from the time the transaction was recorded on the 18^{th} of the month to the end of the month. The USD value of the account receivable at the end of the month is $1,535,000 resulting in an economic loss to the company of $35,000 since the transaction was initially recorded.

Accounting Standards in the United States and internationally provide a framework for the accounting and reporting requirements for translation of foreign currency business transactions and the preparation of financial statements when foreign currency business transactions are present in the general ledger accounts. The accounting and reporting requirements are designed to (1) provide information that is generally compatible with the expected economic effects of a rate change on an enterprise's cash flows and equity, and (2) reflect in consolidated financial statements the financial results and relationships as measured in the primary currency in which each entity in the enterprise conducts its business (referred to as its “functional currency,” which may be the same or different from the reporting currency). Translation of foreign currency business transactions can be “realized” when the actual value of the transaction is known due to the collection, payment, adjustment or clearing of a transaction during the course of an accounting period, or “unrealized” when the economic value of an “open” foreign currency business transaction is calculated and the value in the general ledger is adjusted during the month end consolidation processes. Both the gains and/or losses associated with realizing the actual economic value of a foreign currency business transaction and the adjustment to the general ledger resulting from the revaluation of an open foreign currency business transaction to its current economic value at the end of an accounting period are posted to foreign currency gain/loss accounts in the income statement of the company.

Proper multicurrency accounting is a difficult proposition. The major ERP systems (SAP, Oracle, Peoplesoft, JD Edwards, etc) are complex, difficult to configure, and equally difficult to maintain. Accounting teams are generally lean, stretched to the maximum in what they are asked to do, and turnover is common. The complexity of the ERP systems and the leanness of the accounting teams contribute to an environment where correct multicurrency accounting practices and processes are difficult to effectively implement and maintain. One of the main reasons for this is that companies have no tools to test the effectiveness of their multicurrency accounting practices.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an embodiment of a system with a foreign exchange gain/loss analyzer that analyzes multicurrency accounting data.

FIGS. 2A-2E illustrate an embodiment of an interface for a foreign exchange gain/loss analyzer.

FIG. 3 illustrates a representation of an embodiment of a foreign exchange gain/loss analysis report.

FIGS. 4A-4G illustrate an example of data analyzed by an embodiment of a foreign exchange gain/loss analyzer to generate an analysis report.

FIG. 5 is a flow diagram of an embodiment of a process for analyzing multicurrency accounting data.

FIG. 6 is a block diagram of a computing system on which embodiments of the invention can be implemented.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

### DETAILED DESCRIPTION

As provided herein, analysis tools for management of foreign exchange exposure risk enable testing the effectiveness of multicurrency accounting practices. Based on company transaction data, the tools can generate reports to indicate what level of gain or loss due to currency exposure is expected, and what actual gain or loss due to currency exposure occurred. In one embodiment, the report can allow drilling down to the data to determine where discrepancies may have developed.

The analysis tools provide the analytics necessary to test the effectiveness of multicurrency accounting processes at the business entity level of the company's accounting data. The analysis can provide a calculation of what the expected foreign currency gain/loss in the income statement is based upon: 1) foreign currency exposures at the beginning of the evaluation period (which may also be referred to as a time interval, time period, or reporting period) and their associated foreign currency exchange rates; 2) foreign currency exposures at the end of the evaluation period and their associated foreign currency exchange rates; 3) change or delta in foreign currency exposure during the evaluation period and the foreign currency rate attributed to the delta by the business systems and/or accounting processes for recording transactions (as described in more detail below); and, 4) the value and costs of corresponding derivative instruments acquired by the company to mitigate foreign currency risk.

In one embodiment, the analysis tools compare the expected foreign currency gain/loss to the actual foreign currency gain/loss recorded for each business entity in the company's income statement during the evaluation period. Differences in the calculated or expected foreign currency gain/loss and the actual foreign currency gain/loss warrant investigation by the company. Differences may indicate underlying issues in the practices and processes of multicurrency accounting currently existing within the company.

The benefits of the analysis tool and its associated reporting described above are focused primarily at the Finance Team or Controllers area of the company. With such a tool, they can ensure that the financial systems of the company are configured and operating in a way to ensure that the proper data is being evaluated in the proper way to provide correct gain/loss results. Additional benefits can be realized by the Treasury organization, for example, if Treasury is tasked with managing the foreign currency exposure of the company through the use of derivative instruments. The foreign currency data that Treasury utilizes to calculate the foreign currency exposure of the company and manage the risk with derivative instruments should be the same data that is utilized to calculate expected foreign currency gain/loss for the Controllers area as described above. By uploading and introducing into the tool the results of the derivative instruments for the evaluation period by entity (and potentially separated by actual derivative results and cost/benefit of the derivative instruments), companies are able to report on the effectiveness of Treasury in managing the foreign currency exposure represented by the foreign currency exposure data in the underlying ERP and accounting systems. Differences outside of the company's risk tolerance can be investigated to determine the root cause of the difference. Once the root cause is determined, the company can make appropriate changes to systems and processes to drive future differences to a level within the risk tolerance.

Observe that the tools provide visibility into what has traditionally been a tremendous amount of data that is worked with in different ways by separate organizations within the company. Although the organizations of the company are separate, there is an interrelationship based on the underlying data. Analyzing how the data is processed by the two organizations can ensure proper processes at both ends.

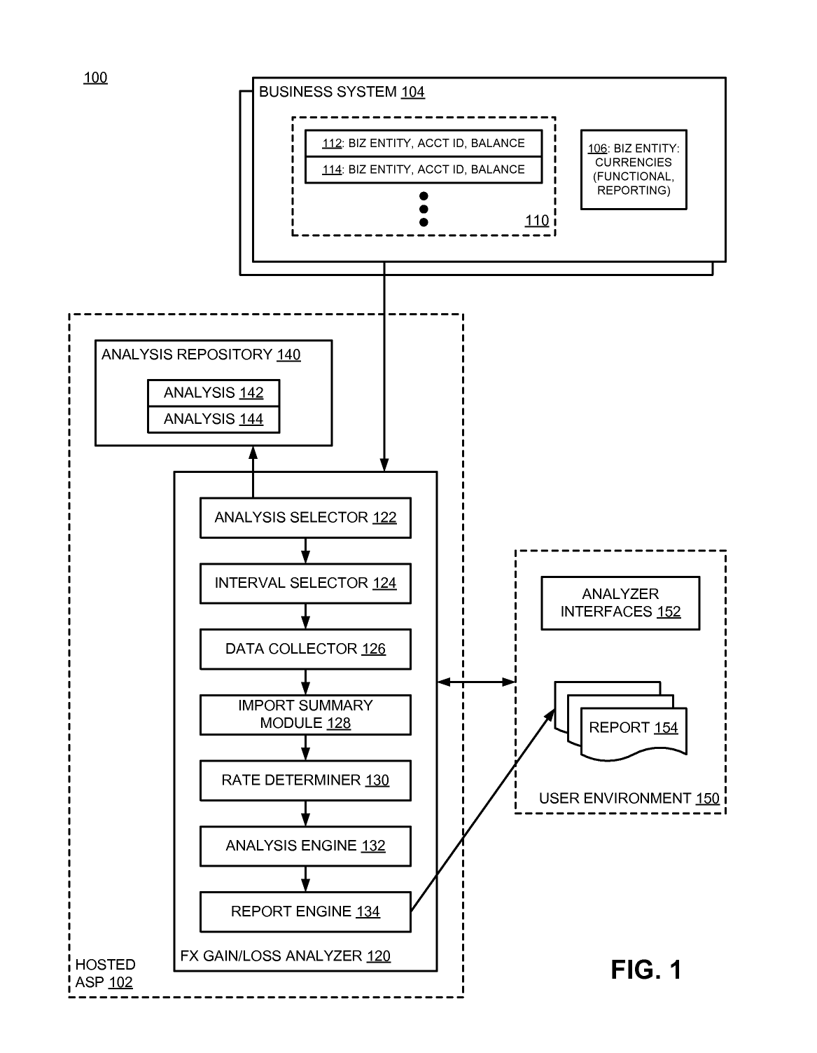

FIG. 1 is a block diagram of an embodiment of a system with a foreign exchange gain/loss analyzer that analyzes multicurrency accounting data. System 100 represents a foreign currency gain/loss analysis system, which is an interaction of different components. FX gain/loss analyzer 120 provides the foreign currency gain/loss analysis, and may be considered an analysis tool, as described above. FX gain/loss analyzer 120 receives accounting data from one or more business systems 104. A user can interface with FX gain/loss analyzer 120 via user environment 150.

Business system 104 includes accounting data 110, which may be rows of summary account balances from a general ledger or a financial system. The general ledger data may be in a single location, or may be a collection of data in multiple files, or even systems. The general ledger data is accounting data, which can be selectively passed to analyzer 120, or accessed/obtained by analyzer 120. Business system 104 represents any type of system that stores accounting data, and may be an ERP system, a specialized accounting system, or a system that stores spreadsheets or other data files. Accounting data 110 includes account balances representing a summarization of the various transactions of the company. Accounting data 110 can be stored in rows of data, or at least conceptually thought of as rows of data, as depicted with rows 112 and 114. Each row may represent a separate transaction, indicating a business entity, account identifier, transaction currency and balance. Other data may be included in the rows of data, for example, if a transaction is an intercompany transaction, the intercompany information could be included in the row of data (unless the intercompany relationship was predefined through the use of a designated account or otherwise defined within the system).

In one embodiment, business system 104 includes data 106, which defines information about the various business entities identifiable in accounting data 110. Such information may include a definition of the reporting and/or functional currencies of a business entity. Such information could be stored in a separate configuration document or file. The information may be accessed by analyzer 120 when accounting data 110 is obtained. Note that the principles herein with regard to foreign currency management are pertinent to multicurrency accounting data, but may be irrelevant when dealing with accounting data that deals only with transactions having a single currency (and that currency is the same as both the functional currency and the reporting currency). Thus, reference herein to accounting data can be understood to mean multicurrency accounting data, or accounting data having information relating to transactions where more than one currency is involved.

User environment 150 includes hardware and software components to enable a user to interact with analyzer 120. In one embodiment, analyzer 120 is located on a separate device from a user device the user employs to access the analyzer. Business system 104 may also be on a separate device. In one embodiment, all three of the user devices, analyzer 120, business system 104 and user environment 150 are separate devices. In an implementation where analyzer 120 and the user device are separate, user environment 150 includes networking hardware to exchange data with analyzer 120. Analyzer interfaces 152 may include the hardware interface components, as well as the software (e.g., user interface) components that enable the interaction of a user with analyzer 120. In one embodiment, analyzer interfaces 152 include data rendered in a web browser. Analyzer 120 generates (as described in more detail below) one or more reports 154, which can be provided to user environment 150. Note that passing report 154 does not necessarily involve sending the data underlying the report, or even sending a document representing the report, although it may. Report 154 as presented in user environment 150 may simply be a visual representation of data generated and hosted by analyzer 120, such as UI information passed from analyzer 120 to user environment 150.

In one embodiment, analyzer 120 is provided via an application service provider (ASP) hosted environment (hosted ASP 102) accessible via a network (not specifically depicted). Hosted ASP 102 includes hardware components, such as memory and one or more processors or processing resources. The environment provided by hosted ASP 102 may receive information via a browser (not shown) that is part of user environment 150. Although described in reference to an ASP hosted environment, it will be understood that the description of various functional components can be implemented in other ways. In one embodiment, hosted ASP 102 includes a server accessible via a network, such as the Internet. Specific network interfaces are not illustrated, but are understood by those skilled in the art. Hosted ASP 102 includes hardware resources, such as processor(s), memory, network interface(s), storage components, display component(s), etc. Many hardware resources also include specific drivers or software to enable the hardware resources. Alternatively to a hosted ASP environment, analyzer 120 may be stored and executed from hardware resources local to a user device.

Analyzer 120 includes one or more functional components, such as those illustrated in FIG. 1. It will be understood that the components names are arbitrary labels, which could be different in different implementations. Additionally, more or fewer components could be used in analyzer 120, and certain components may implement more than a single function. Thus, while illustrative of general functionality, analyzer 120 could be more or less complex than shown.

In one embodiment, analyzer 120 includes analysis selector 122 to enable analyzer 120 to identify an analysis to perform. Thus, an analysis may be started, halted, saved, and later resumed. The analyses may be selected, for example, from a list. In one embodiment, a selected analysis is a template, such as one that could generate an analysis for thirty days prior to the current date, or thirty days prior to the last reporting date, or an analysis for the previous accounting period, etc. As mentioned previously, selecting an analysis could also refer to opening to review, and possibly continue executing, a saved analysis. A saved analysis could save all state associated with the analysis, to prevent a user from needing to again configure the analysis tool or update data. In one embodiment, hosted ASP 102, or another environment on which analyzer 120 executes, includes analysis repository 140, which may store analyses a user may select from. For example, analysis repository 140 includes analysis 142 and analysis 144, which may be saved analyses or analysis templates (referring to an analysis with predefined or selectable parameters that set the configuration for what data will be analyzed by analyzer 120).

Interval selector 124 enables analyzer 120 to analyze data within a particular time interval. The time interval may be the same as or different from (either shorter or longer) an accounting period. A user may select the interval through a user interface. The interval includes a beginning time and an ending time. The beginning and ending of the interval are the dates for which data is obtained. In one embodiment, a default interval could be used. In another embodiment, if an interval is not selected, analyzer 120 obtains only current data, which provides a snapshot of foreign currency gain/loss for the most recent time interval for which the analyzer 120 has account data.

Data collector 126 enables analyzer 120 to obtain and/or extract accounting data from business system(s) 104. Data may be accessed by analyzer 120. The data may be uploaded to analyzer 120 for evaluation. The data can be accessed from one or more business systems, which may be different systems. The systems do not necessarily even have to be compatible with each other, as long as they are able to pass accounting data. The accounting data may have preferred or required formats, and/or supported formats. Data not in a supported format may need to be translated and/or cleansed prior to being used by analyzer 120. Data may be spreadsheet data, generic tables, and/or XML (extensible markup language) data. In one embodiment, where data is obtained from different systems, business entities may be identified (and frequently are) by different identifiers in the different systems. Thus, data collector 126 may further provide a mapping between the different business entity identifiers as referencing the same business entity. When computations are performed on accounting data for particular business entities, the right accounting data will be obtained and used in the calculations because all accounting data referencing a particular business entity will be used when calculations are made for that particular business entity, whatever identifiers may be used to represent it in the different systems.

In one embodiment, analyzer 120 includes import summary module 128 to generate a summary of data that is obtained or uploaded to analyzer 120. In one embodiment, the summary module 128 may report on the number of entities for which account data was or was not loaded, the number of accounts loaded for each entity, and error information for data that was incorrect in format, type, or value.

Rate determiner 130 enables analyzer 120 to determine exchange rates for calculations that are part of the analysis. In one embodiment, there are three or four exchange rates needed. The first is a beginning exchange rate between the transaction currency of the account balance and the functional currency of the business entity at the beginning of the time interval. The second is an ending exchange rate between the transaction currency of the account balance and the functional currency of the business entity at the ending of the time interval. Note that while these exchange rates both involve the same currency conversion, the exchange rates constantly change; thus, the exchange rate for a currency at the beginning of the interval might be different than at the ending of the interval.

The third exchange rate is a delta exchange rate between the transaction and functional currencies that is associated with business transactions recorded between the beginning and end of the time interval. There are a number of ways the delta exchange rate can be computed, depending on the level of accuracy desired by the user. A less-accurate calculation of the delta exchange rate would be to simply average the exchange rate at the beginning and ending dates of the exposure period (time interval). A more accurate approach takes a daily average, by determining the exchange rate for each day of the exposure period, and averaging all the exchange rate values together. An even more accurate approach would require additional information. Specifically, the date of every transaction that contributed to the delta account balance over the interval can be determined. Based on the knowledge of when transactions took place, the system could provide a weighted average, rather than a blind daily average, by determining the exchange rate for each transaction, and averaging based on the value of the transaction. Obviously, the more precise the calculation, the more computation required. Exact precision may not be required to simply determine from the calculated exposures whether or not the company is within expected tolerances on the reported foreign currency gain/loss by entity.

In one embodiment, the functional currency and the reporting currency are not the same. In such an implementation, there will be a currency exchange between the functional and reporting currencies, which may be labeled a translation exchange rate. The translation exchange rate is used in the calculation of the foreign currency gain/loss in the reporting currency and is typically based on a daily average of the exchange rate over the interval. Alternatively, the translation exchange rate may be based on the exchange rate at the ending of the time interval. Note that even in a case where the functional and reporting currencies are the same, a system could be considered to “determine” the translation exchange rate by determining that the currencies are the same and so making the exchange rate equal to 1. Thus, a calculation from functional to reporting currency can always be performed, by multiplying the value in the functional currency by the translation exchange rate, where the translation exchange rate is 1 when the functional currency is the reporting currency.

Rate determiner may obtain exchange rates in any of a number of ways. In one embodiment, exchange rate information may be inherent within accounting data 110 that is obtained from business system 104. In another embodiment, a user may supply exchange rates through user interfaces that are part of analyzer interfaces 152. The user may provide any or all of the exchange rates: the beginning, ending, and/or translation rates. In another embodiment, rate determiner 130 includes the ability to obtain an exchange rate from a recognized electronic exchange rate source (e.g., Oanda, Bloomberg, etc.), which may be selectable by the user. Alternatively, a default rate source may be used by analyzer 120. There is no requirement that the same exchange rate source be used for all exchange rates mentioned above, and instead, a combination of rate sources can be used to determine each of the individual exchange rates discussed above.

Analysis engine 132 enables analyzer 120 to perform the analysis computations described herein. In general, an analysis may be performed in a couple of different ways. In a first approach, beginning and ending exposure is calculated for beginning and ending exposure data elements obtained from the multicurrency accounting information 110. Such beginning and ending exposure data elements are on the account level, because the exposure data elements identify business entity, account, and summary balance by currency for the account. The calculation of expected foreign currency gain/loss in the functional currency is calculated by:
1) computing a beginning exposure in the functional currency based on the summary balance of the beginning exposure data element and the beginning exchange rate for the transaction currency in relation to the functional currency at the beginning of the time interval;
2) computing an ending exposure in the functional currency based on the summary balance of the ending exposure data element and the ending exchange rate for the transaction currency in relation to the functional currency at the end of the time interval;
3) computing a delta exposure in the functional currency based on a difference between the summary balances of the beginning and ending exposure data elements and the delta exchange rate associated with the time interval for the transaction currency and the functional currency; and
4) generating the expected foreign currency gain/loss in the functional currency by combining the beginning exposure and the delta exposure to form an intermediate result, and taking the difference between the intermediate result and the ending exposure.

The expected foreign currency gain/loss in the reporting currency can further be calculated by multiplying the expected foreign currency gain/loss in the functional currency by the translation exchange rate between the functional currency and the reporting currency at the end of the time interval. As mentioned above, the translation exchange rate can be 1 when the currencies are the same.

Observe that the above analysis provides the expected gain/loss at the account level for each transaction currency, which information could then be consolidated to provide the expected gain/loss at the business entity level (by combining all accounts for all transaction currencies for a given business entity). An alternative approach could be to first obtain the accounting data, and normalize it for business entities by combining all summary balances for all accounts for the same transaction currency identified for a business entity. Such transaction currency-entity-level exposure data elements can be created for the beginning and end of the time interval. Then analysis engine 132 can perform the calculation of expected foreign currency gain/loss in the functional currency by the same four operations (1) to (4) listed above.

The alternative analysis provides the expected gain/loss by transaction currency for the business entity, which information could then be consolidated to provide the expected gain/loss at the business entity level (by combining all gain/losses for all transaction currencies for a given business entity). Additionally, as before, the expected gain/loss in the reporting currency can be calculated by applying the translation exchange rate to the expected gain/loss in the functional currency.

While the above is described in reference to a particular business entity, it will be understood that accounting data may include thousands or even millions of rows of transaction data, which may reference tens or hundreds of business entities. A complete report for some companies may involve performing the above calculations for all of those tens or hundreds of separate business entities, and reporting expected gain/loss for all of the separate business entities.

In addition to computing the expected foreign currency gain/loss, analysis engine 132 may also provide comparison analysis between the expected (calculated) results, and the actual foreign currency gain/loss from the company's business systems. Data collector 126 may collect actual foreign currency gain/loss data (“actuals”) for a given business entity for the time interval. In one embodiment, analysis engine 132 compares the actuals to the calculated expected foreign currency gain/loss for each business entity for the time interval. The comparison can reveal, side by side in a report, how the actual results as obtained by the system processes compares to calculated expected results.

Additionally, in one embodiment, data collector 126 may obtain derivative instrument (e.g., hedge results) data corresponding to the actual currency exposure as reported by the business systems. The derivative instrument results may be due to a change in spot foreign currency exchange rate for the time interval (spot-based), as well as a change in the value of the instrument based upon associated interest rate differentials (forward points) or other costs (option premiums). In addition to the variable elements of the derivative instruments, the derivative instruments have an associated cost based upon market costs for the derivative instrument (spread). The analysis will detail the effectiveness of the Treasurer in managing a foreign currency exposure based upon spot-based value changes, as well as provide the basis for a cost/benefit analysis of the derivative instruments based on the spread and forward points associated with the derivative instrument.

Report engine 134 generates one or more reports 154, which may include text output, graphical output, tables, or other form of data output. Report engine 134 may generate reports for any and all of the calculations and analyses described above. Examples of what the reports might include and examples of one possible layout are provided below. In general, the reports indicate the calculated expected foreign currency gain/loss. In one embodiment, the report provides links to the underlying data on which the calculations were based. Thus, if a particular result seems interesting (e.g., there is a significant discrepancy between an expected and actual result), the user may link to and view the data that caused the result. While the particular data element(s) involved may appear to be nothing more than another data value when viewed in the accounting systems, the data element can be considered as a needle in the haystack of data that indicates an error in the accounting practices, processes, and/or systems. Finding that needle may be totally infeasible in almost any circumstance with traditional accounting approaches. However, analysis engine 132 can act as a needle-finder to identify the potential system and process problems.

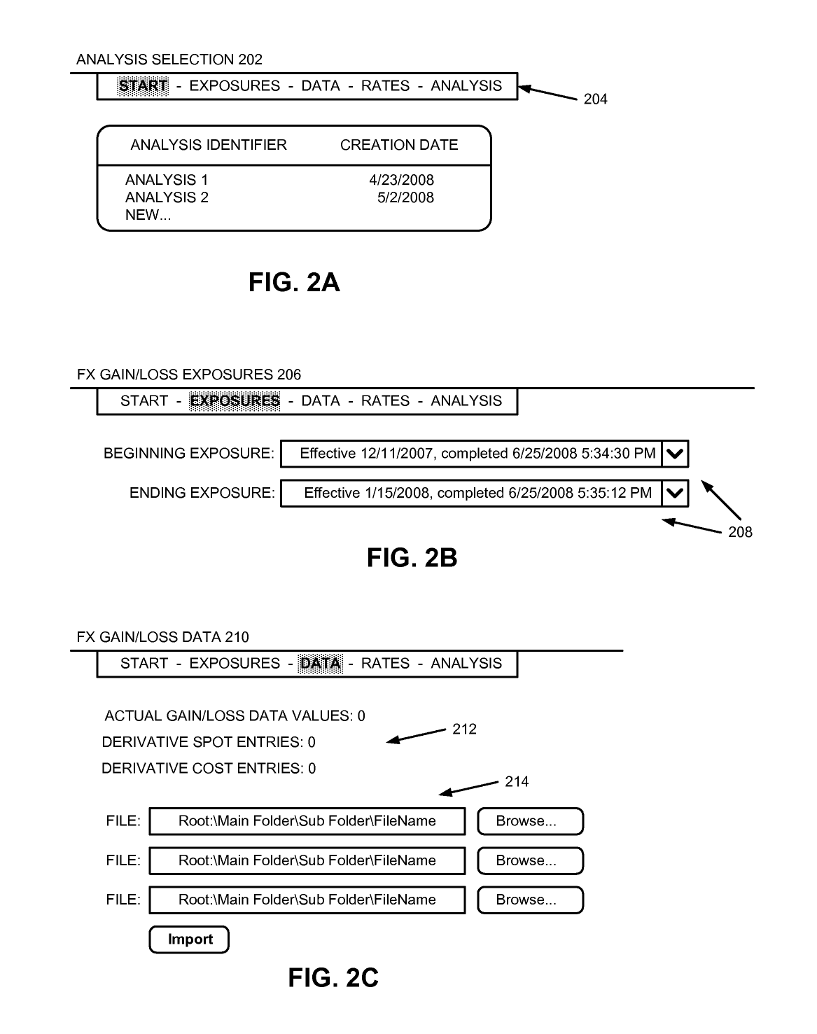

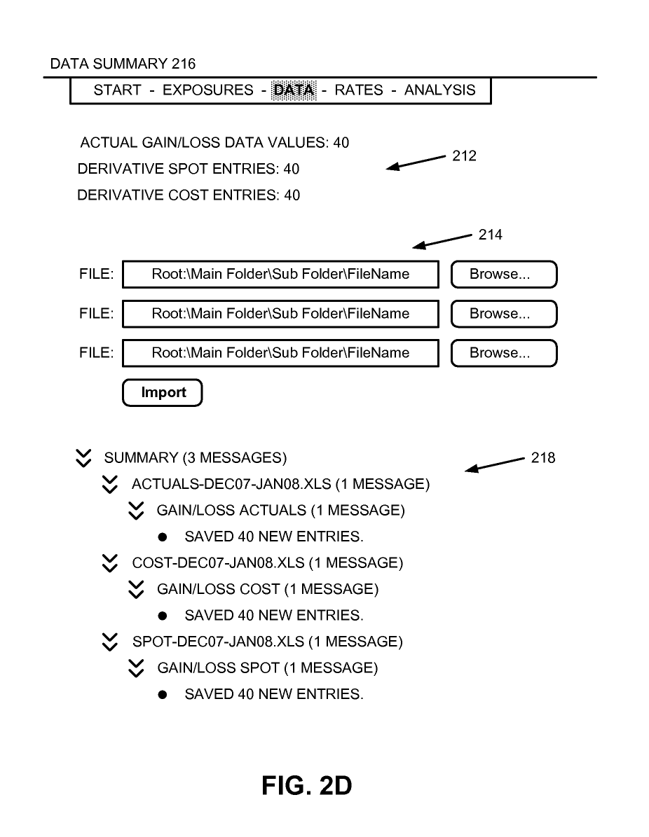

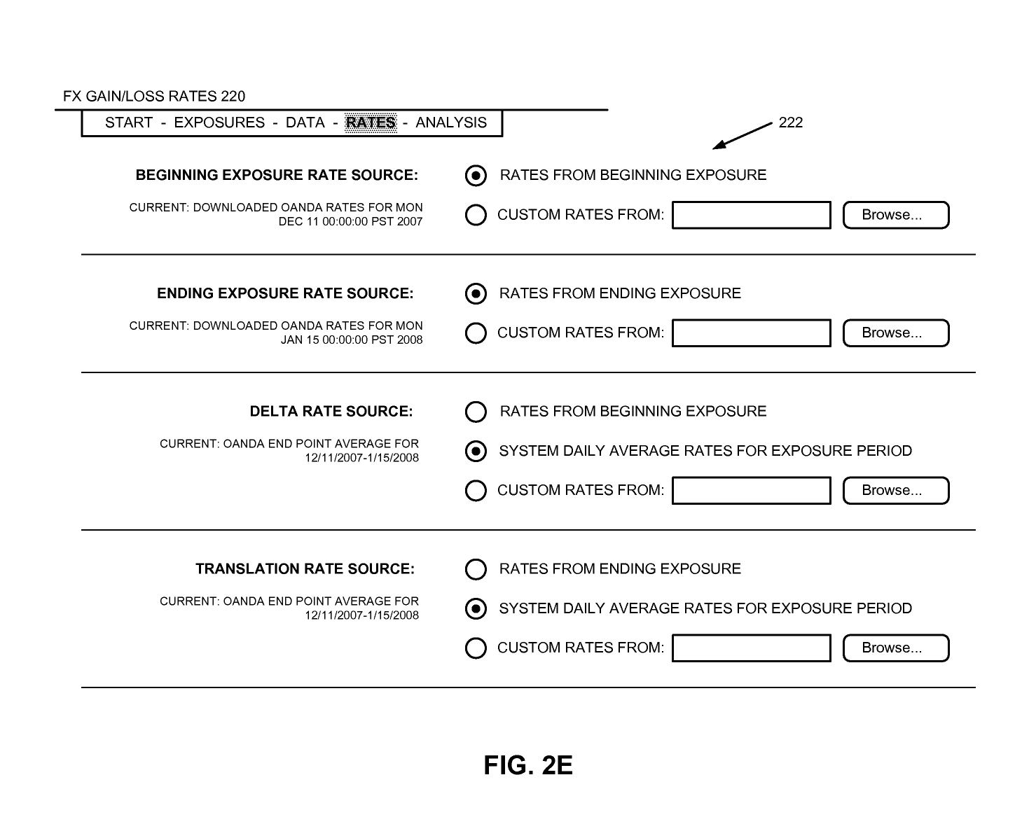

FIGS. 2A-2E illustrate an embodiment of an interface for a foreign exchange gain/loss analyzer. Although not specifically shown herein, in one embodiment, certain configuration settings may be provided by a user that could be applied to every analysis performed on the system. Such configuration settings may be information about the company and/or its subsidiaries (e.g., business structure), selection of rate source, or other configuration. While it is discussed above that business entity identifiers may be resolved outside of the analysis engine, it is also possible to configure the analyzer with configuration settings to define ERPs or accounting systems, and define business entity identifiers for those systems.

FIG. 2A illustrates an example of an interface for analysis selection 202. Analysis selection 202 may correspond, for example, to interaction with analysis selector 122 of FIG. 1. Observe process status bar 204, which shows potential phases of the analysis process or a wizard, and provides an indication of what phase is being performed. In one embodiment, the system executing the analysis will step through the phases automatically. Thus, upon completion of one phase, the next phase may automatically be started. Status bar 204 may be interactive to allow a user to select the phase to work on. The analysis could be saved at any time, and the data or configuration of all phases can be saved to allow the user to start where the analysis was left off previously. As illustrated, a user may be presented with the option to select an analysis by analysis identifier (arbitrarily “named” Analysis 1 and Analysis 2), or begin a new analysis. The creation date of the analysis may be shown to further indicate what analysis is identified in the list. Other information could also be shown to indentify an analysis.

FIG. 2B illustrates an example of an interface for selecting FX gain/loss exposure data sets 206 for the beginning and end of the time interval. FX gain/loss data sets 206 may be selected, for example, via interaction with interval selector 124 of FIG. 1. Beginning and ending exposure data sets may be selected via drop-down mechanisms 208. Alternatively, a calendar display could be provided to allow user interaction. In one embodiment, the options in drop-downs 208 or on a calendar interface may coincide with reporting activities, or the completion of data sets that will be imported for analysis. Such selections may be defined by a user. Arbitrary dates could also be used, which may require additional filtering to select data records for analysis. A common selection of a time interval would be a period-end to the next period-end, which could be month-to-month (whether the 20th of each month, or the end of each month, etc.), for example.

FIG. 2C illustrates an example of an interface for selecting additional FX gain/loss data 210. FX gain/loss data 210 may be imported, for example, via interaction with data collector 126 of FIG. 1. In one embodiment, FX gain/loss data interface 210 includes summary indicators 212, which indicate the number of records received of particular types. In one embodiment, summary indicators 212 automatically update to reflect an upload of the same data type indicated (for an example, see FIG. 2D below). In one embodiment, the analyzer only deals with one file per data type. Thus, importing a second file for derivative spot entries may operate to replace, rather than add to, a first imported file for derivative spot entries. The files imported include a field in a template and/or metadata to indentify the data type. Thus, the files themselves may be recognized as “actual gain/loss data values,” derivative spot entries, or derivative cost entries.

One or more files could be entered. As illustrated, the system may accept up to three files, one corresponding to each data type. Each file can be designated in input fields 214, which identify a path to a file to import. Many alternatives are possible. For example, specific input fields 214 can correspond to specific data types and/or specific summary indicators 212. As another example, a single file import field can be used, and files uploaded in succession.

FIG. 2D illustrates an example of an interface for providing data summary 216. Data summary 216 may be provided, for example, by import summary module 128 of FIG. 1. Data summary 216 shows a change to summary indicators 212, indicating the number of entries imported into the system of the analysis engine. In one embodiment, the number of entries is the number of business entities identified in the imported files. Summary 218 is shown as a tree structure, indicating the names of the uploaded files, along with the data type of the file, and the number of entries in the file. For example, the file “Actual-Dec07-Jan08.xls” was uploaded, identified as a “gain/loss actual” data type, having 40 entries. Similar information is illustrated for the other files. If upon review of the summary a user determines that a file was improperly imported, or does not have the correct information based on the summary, or a file is missing, input fields 214 may be used to import a new file.

FIG. 2E illustrates an example of an interface for selecting FX gain/loss rates 220. FX gain/loss rates 220 may be selected, for example, via interaction with rate determiner 130 of FIG. 1. FX gain/loss rate selector interface 220 allows the selection of the source of one or more of the currency exchange rates used in calculation on the analysis of the accounting data. Each of the potential exchange rates discussed above is illustrated in FIG. 2E. Beginning exposure rate source is shown as currently the rates downloaded from OANDA at the beginning of the exposure period to be analyzed. Such rates could be considered system or company defaults. In one embodiment, such defaults are rates that are part of the accounting data received (and could be designated by metadata, or by field, such as in a template). Similarly, the ending exposure rate source is shown as defaulting to rates downloaded for OANDA at the end of the exposure period. Either source could be modified with selections 222, such as by browsing and finding, and/or inputting an alternative rate source.

Delta rate source and translation rate source are shown as defaulting to a system daily average for the exposure period, which may be rates that were downloaded and are found in the accounting data. Delta rate source shows an option in selections 222 for rates from the beginning exposure, and translation rate source shows an option in selections 222 for rate from the ending exposure. Other selections could be provided. Additionally, other selections could be provided for the beginning exposure rate source and ending exposure rate source. For example, various different rate source services could be explicitly identified and allowed to be selected. All rate source selections can also specify a custom rate. As mentioned above, the custom rate for the delta rate source may involve various techniques to improve the accuracy of the calculated expected foreign currency gain/loss exposure is desired to be detailed, rather than a more “ballpark” estimate.

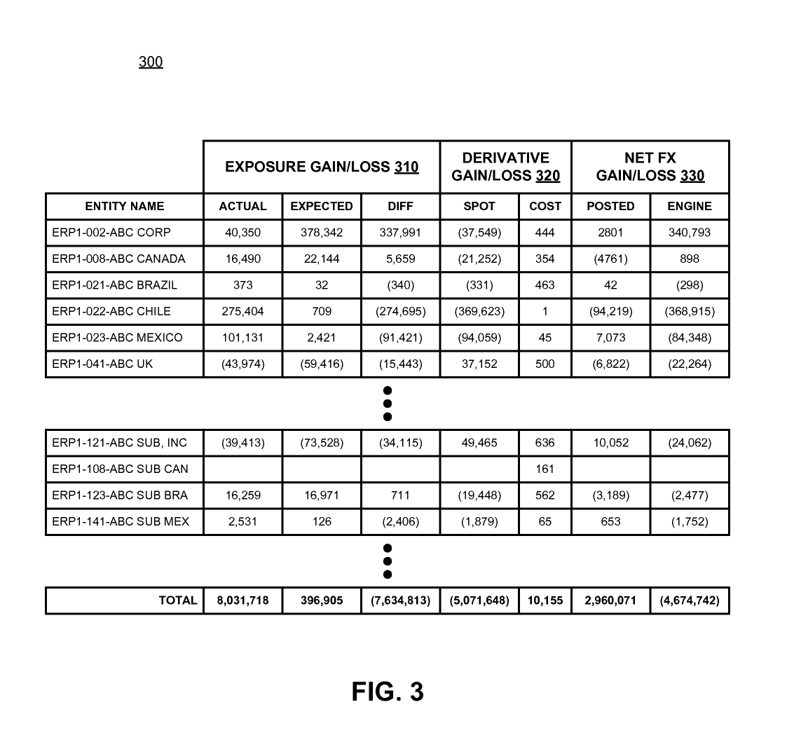

The Analysis phase of the wizard or analysis process is not shown with these figures, but is shown immediately following as an example under FIG. 3. FIG. 3 illustrates a representation of an embodiment of a foreign exchange gain/loss analysis report. Report 300 can be understood as having several parts, shown as exposure gain/loss 310, derivative gain/loss 320, and net foreign exchange gain/loss 330. Report 300 is organized by business entity. For the purpose of what is generally sought with report 300, organization by business entity is convenient. However, report 300 is not limited to being organized by business entity, and could be organized by account, for example. Report 300 shows different entities associated with “ABC Corp,” each identified by an ERP identifier associated with the business entity in the system. In addition, subsidiary entities identified as “ABC SUB” entities are listed in report 300. Again, the organization shown is for purposes of example. Different companies might find it preferable to separate reports by grouping particular business entities into sub-groups that are analyzed together.

Exposure gain/loss 310 includes columns for Actuals, which are the foreign currency gain/loss data as recorded in the accounting system, “Expected,” referring to the analysis engine calculations that provide an expected gain/loss based on the underlying accounting data, and diff (difference), referring to the difference between the two. The Actuals may be thought of as what the accounting system has recorded in the FX gain/loss accounts in the income statement for the interval period (including realized FX gain/loss, unrealized FX gain/loss and any accounting adjustments), while the Expected shows what FX gain/loss is expected to be based on the underlying foreign currency exposure data in the ERPs/accounting systems. Depending on the tolerances established by the company, some of the entries in the difference column can be passed over. For example, perhaps the entries for ABC Canada do not represent a high enough dollar value, or a significant enough percentage of difference to represent a “problem” under the company's standards. In one embodiment, in addition to a difference value, exposure gain/loss 310 includes a difference percentage column, which can indicate a percentage of variance. Some companies may pass over any amount smaller than a threshold, while others may wish to investigate entries based on percentages. For example, perhaps the difference entry for ABC Brazil is a small enough value ($340) that the company is not interested in looking at it. However, maybe the company would like to investigate the entry even though it is not a significant value compared to some other entries, simply because the percentage of variance (over 1000%) is outside a tolerance level of the company. Thus, the report provides visibility to the user and allows more informed analytics and decision-making. At the very least, the person in charge can know where to look to improve processes and system configurations.

Derivative gain/loss 320 illustrates details regarding derivative instruments that are intended to hedge the risk associated with the various business entities. Derivative gain/loss 320 has two columns of information, the first is Spot-based results, and the second is Cost. Spot refers to the result (gain/loss) associated with the derivative instruments for the interval period. This Spot value as compared to the expected foreign currency gain/loss can indicate the effectiveness of the Treasurer in hedging against currency exchange risk. Observe that the Actuals and Expected values are not always close. To the extent that a particular system or accounting error resulted in the expected being correct and the Actual being incorrect, a company may have over or under-hedged significantly. Correction of the underlying system and process issues can result in a significant reduction of this risk. The Cost column can actually refer to two things: 1) the cost/benefit of the derivative instrument based upon market costs for the derivative instrument (spread); and, 2) associated interest rate differentials (forward points) or option premiums for the time interval. As will be understood, the forward points refers to differences due to the embedded interest rate of the derivative instrument, while the spread refers to what is being charged (e.g., fees imbedded in the bid-offer spread) by the financial institution to acquire the derivative instrument.

The net FX gain/loss 330 is the net result of the exposure offset by the derivative instrument spot result. There are two columns, the Posted value that is based on the actual reported value, and the engine value, which is based on the expected value calculated by the analysis engine. The values of each entry in the columns are understood as Posted=Actual+Spot, and Engine=Expected+Spot. The “Engine” refers to the results as calculated through the analytics engine discussed herein.

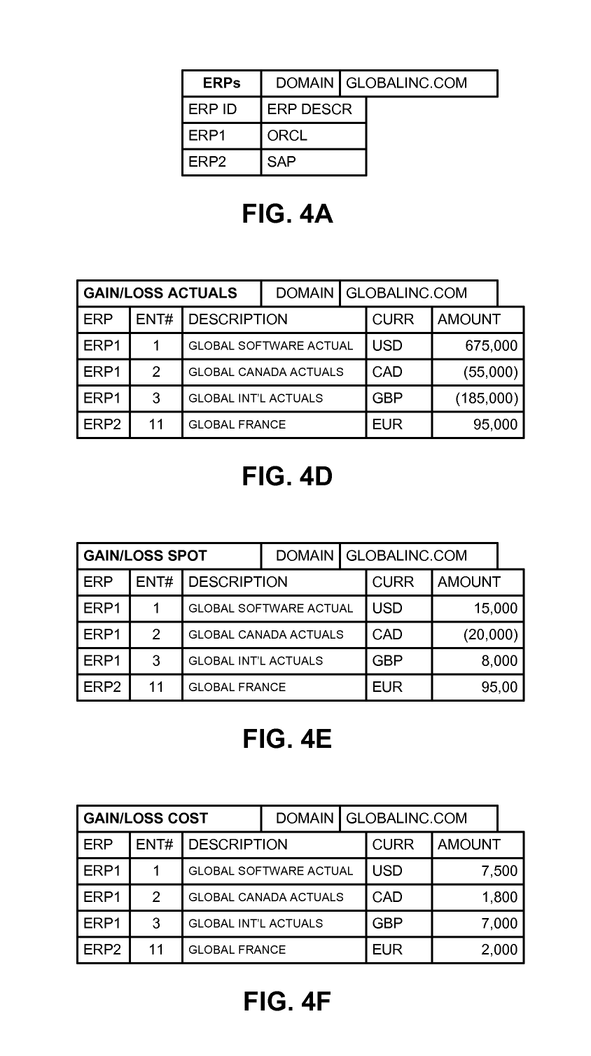

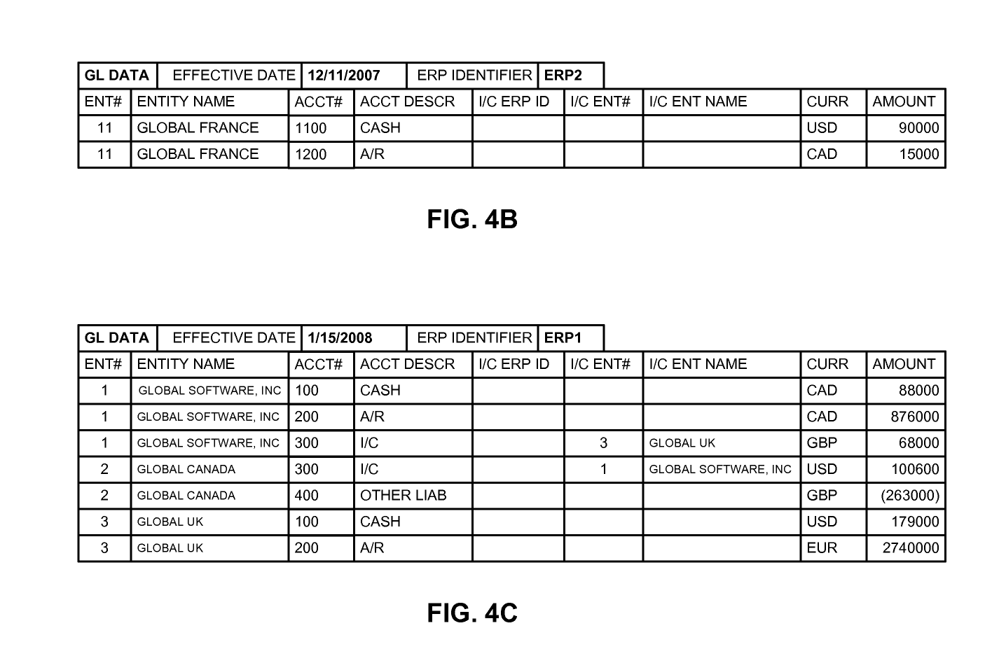

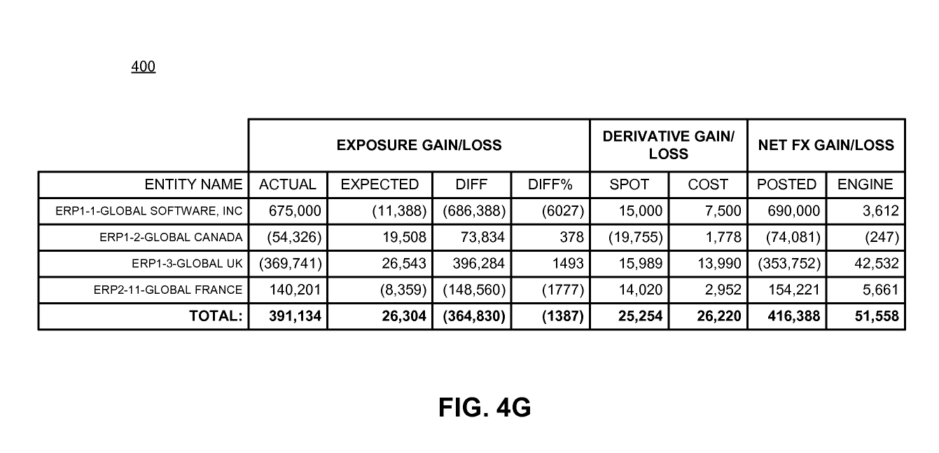

FIGS. 4A-4G illustrate an example of data analyzed by an embodiment of a foreign exchange gain/loss analyzer to generate an analysis report. The following provides a simplified example of data that is analyzed similar to what is presented previously. The focus here is on the data and the final report, rather than the user interfaces that enable the analysis. FIG. 4A illustrates the configuration data. The ERPs are defined for the domain globalinc.com. The ERPs are identified by ID (ERP1 and ERP2), and corresponding description.

FIGS. 4B and 4C show general ledger (GL) data, which represents the accounting data that is obtained by the analysis engine. There may be more data, and the data shown is extracted from the more complete data. The effective date for FIG. 4B is 12/11/2007, and the effective date for the data of FIG. 4C is 1/15/2008. Each table of GL data also identifies the ERP system from which it was obtained. FIG. 4B illustrates two records, both identifying entity number (Ent#) 11 (Global France). The two records correspond to two Accounts (1100 and 1200), which may each have one or more transactions associated with the account to provide the final summary balance (Amount). Note that there is no intercompany (I/C) information in the intercompany fields, because the transactions are not intercompany. Additionally, each account indicates the Transaction Currency. The data of FIG. 4C can be similarly examined to show Entity Number, Entity Name, Account Number, Account description, Currency and Amount. In FIG. 4C, there are two accounts that identify I/C Entity Numbers, indicating the accounts are intercompany.

FIG. 4D illustrates the gain/loss actuals. The actuals show an Amount that represents the foreign currency gain/loss amount for the time interval as recorded in ERP1 and ERP2 for each entity shown. Note that the exposure can be positive or negative.

FIG. 4E illustrates the gain/loss spot data. The spot data identifies the Entities, their respective Currencies, and the Amount or value of the Spot. FIG. 4F similarly shows gain/loss Cost data for each Entity, each respective Currency, and the Amount of the Cost.

FIG. 4G illustrates one embodiment of a report generated for the analysis. An analyzer as described herein performs the analysis operations described above, and generates report 400. Report 400 has each entity listed by name, including an ERP identifier. Observe the similarities between report 400 and report 300 of FIG. 3. In the Exposure gain/loss, there are columns to indicate the Actual foreign currency gain/loss as recorded in the accounting systems, the calculated Expected foreign currency gain/loss, the Difference, and the Difference Percentage. As can be seen from the numbers in Report 400, there are at least a couple of significant errors in the practices or systems, or at least the application of practices and systems with respect to the data analyzed. There is a total average of more than 1000% difference in Expected and Actual exposures for the time interval of report 400. In one embodiment, one or more entries in report 400 are linkable to the underlying account data on which the calculations were made to identify in the data what could be causing the large discrepancy between Expected and Actual foreign currency gain/loss.

In the Derivative gain/loss, there are columns to indicate the Spot results of the hedges for each of the entities, and the Costs associated with the derivative instruments. The Net FX gain/loss includes columns indicating the Posted exposure (Actual+Spot) and the Engine value (Expected+Spot).

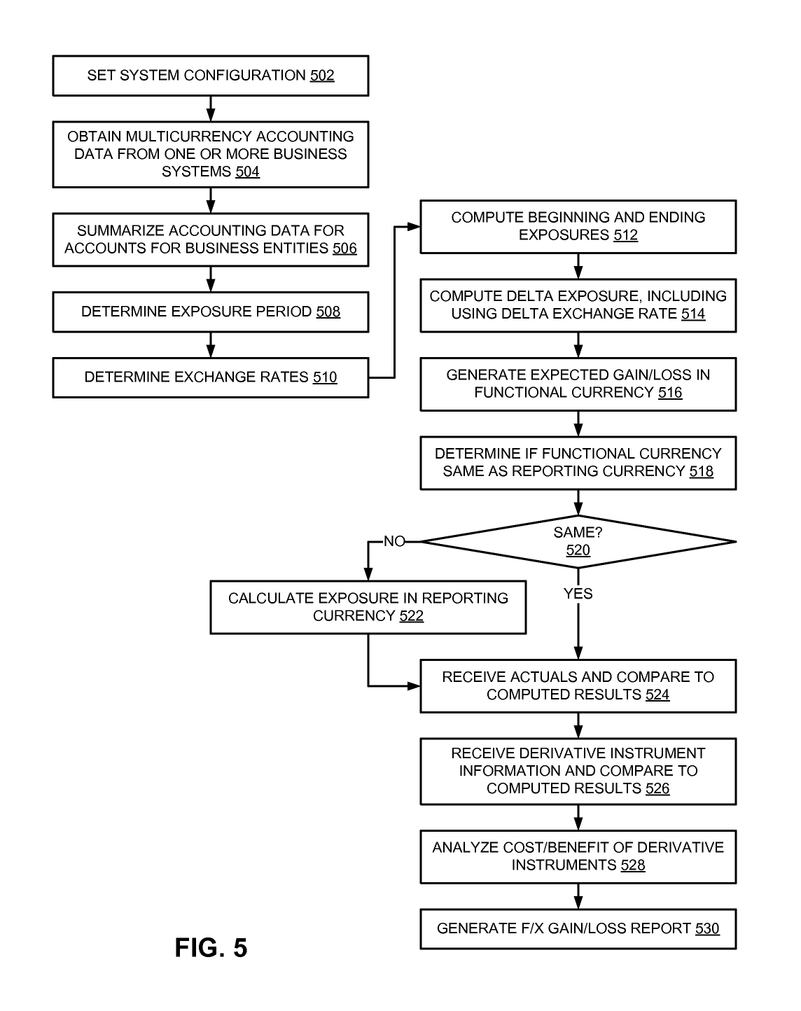

FIG. 5 is a flow diagram of an embodiment of a process for analyzing the foreign currency gain/loss associated with multicurrency accounting data. Flow diagrams as illustrated herein provide examples of sequences of various process actions. Although shown in a particular sequence or order, unless otherwise specified, the order of the actions can be modified. Thus, the illustrated implementations should be understood only as an example, and the process for establishing the secure channel can be performed in a different order, and some actions may be performed in parallel. Additionally, one or more actions can be omitted in various embodiments of the invention; thus, not all actions are required in every implementation. Other process flows are possible.

An analyzer (e.g., analyzer 120 of FIG. 1) operates on data received for a company. The analyzer and/or the system in which the analyzer executes may be provided with certain configuration values to define the company and how the data should be analyzed for business entities of the company. Thus, the system configuration may be set, 502, by a user. The analyzer obtains multicurrency accounting data representing foreign currency exposure from one or more business systems, 504. In one embodiment, the multicurrency accounting information includes intercompany transaction accounting data, where the exposure data elements extracted from the accounting data include a trading partner identifier for an identified account. The trading partner identifier is associated with a separate business entity than the business entity of the exposure data elements. Each business entity may be evaluated individually in the analysis.

In one embodiment, a business system summarizes accounting data for accounts associated with business entities, 506. The resulting summarized accounting data will be on a per-business entity basis, rather than a per-account basis, as may generally be the case with the accounting data. The analyzer determines an analysis period or time interval for which the analysis will be made, 508. The analyzer also determines the exchange rates associated with the various currencies for the various calculations, 510. The determining of exchange rates is described above, and will not be repeated here.

The analyzer computes a beginning and ending exposure in functional currency based on the received accounting data, 512 and the exchange rates associated with the beginning and ending data. The analyzer computes a delta exposure as a difference between the beginning and ending exposures, 514. The analyzer uses a delta exchange rate to compute the delta exposure in a functional currency, 514. Details associated with the delta exchange rate are provided above, and will not be repeated here. The analyzer generates a calculated gain/loss in the functional currency, 516, based on the beginning and ending exposures, and the delta exposure. Calculating the gain/loss in the functional currency may include summing up all calculated gain/loss values for the business entity to form the expected gain/loss in the functional currency.

In one embodiment, the analyzer determines if the functional currency and the reporting currency are the same, 518. If the currencies are the same, 520, the analyzer may either bypass a calculation and simply identify the exposure in the functional currency as the exposure in the reporting currency, or set the exchange rate to one and perform the “conversion.” If the currencies are not the same, 520, the analyzer calculates the gain/loss in the reporting currency based on a translation exchange rate between the functional and reporting currencies, 522. The expected gain/loss for the business entity may now be reported by the analyzer.

In one embodiment, after determining the foreign currency gain/loss in the reporting currency, the analyzer may receive actual foreign currency gain/loss for the interval period and compare the computed results to the actuals, 524. In one embodiment, the analyzer may receive derivative instrument information and compare derivative instrument information to the computed results, 526. In one embodiment, the analyzer may further analyze the cost/benefit of any derivative instruments the company has, 528. The analyzer after performing all the analysis it will perform on the data, generates a foreign currency gain/loss report, 530, such as reports 300 or 400 of FIGS. 3 and 4, respectively.

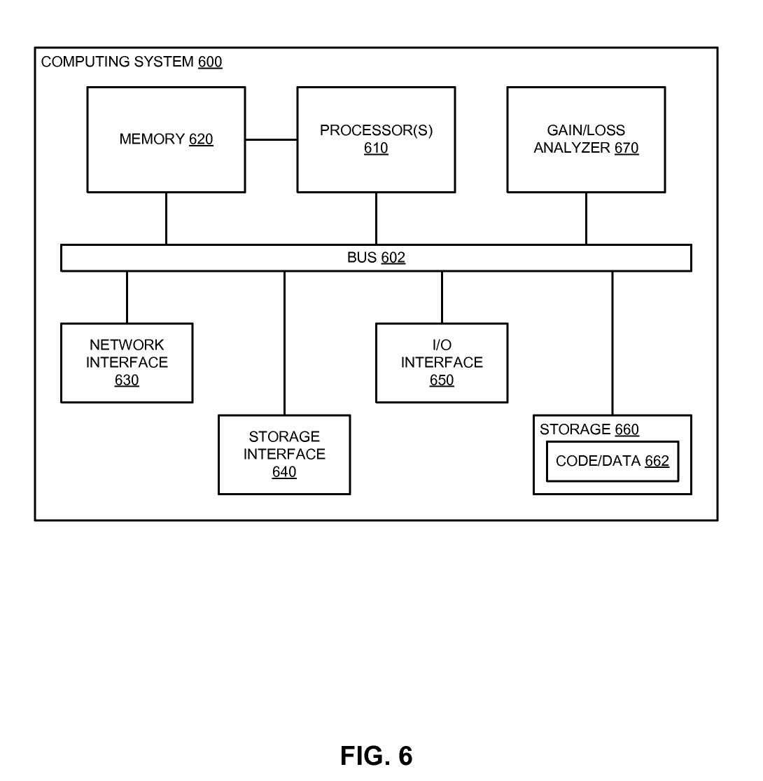

FIG. 6 is a block diagram of a computing system on which embodiments of the invention can be implemented. Computing system 600 represents hardware that might execute an analyzer or analysis engine. Computing system 600 is depicted with various components that may be present in whole or in part, and additional components or subcomponents may also be present. Computing system 600 includes one or more processors 610, which executes instructions and may perform various operations as described herein. Processor 610 may include any type of microprocessor, central processing unit (CPU), processing core, etc. Processor 610 controls the overall operation of the computing system 600, and may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 620 represents the main memory of the computing system 600, and provides temporary storage for code (e.g., software routines or series of instructions, commands, operations, programs, data, etc.) to be executed by processor 610. Memory 620 may include read-only memory (ROM), flash memory, one or more varieties of random access memory (RAM), or the like, or a combination of such devices. Memory 620 stores data and instructions for performing operations, including interacting with user clients, data sources, and/or other event server nodes.

The various components of computing system 600 are coupled to bus 602. Bus 602 is an abstraction that represents any one or more separate physical buses, communication lines, and/or point-to-point connections, connected by appropriate bridges, adapters, and/or controllers. Therefore, bus 602 may include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (commonly referred to as “Firewire”).

Computing system 600 includes network interface 630, which represents hardware and software (e.g., drivers) that enable computing system 600 to communicate with remote devices (e.g., clients, data sources, and/or other event server nodes) over one or more networks. Processor 610 may execute various network stacks to control interfaces to various networks through network interface 630. Computing system 600 may include storage interface/adapter 640, which enables computing system 600 to access attached storage (e.g., a storage area network or other storage subsystem) and may be, for example, a Fibre Channel adapter, a SCSI adapter, etc. Computing system 600 includes one or more input/output (I/O) interface(s) 650, which may include one or more interface components to connect with other electronic equipment, for example, custom connections, blade adapters, etc. Additionally, I/O interfaces 650 can include video, audio, and/or alphanumeric interfaces through which a user interacts with computing system 600. Computing system 600 may include one or more internal storage device(s) 660. Storage 660 can be any conventional medium for storing large volumes of data in a non-volatile manner, such as magnetic, optical, and/or semiconductor-based disks. Storage 660 may hold code and/or data 662 in a persistent state (i.e., the value may be retained despite interruption of power to computing system 600).

Computing system 600 includes gain/loss analyzer 670, which is an abstraction to represent components (software and/or hardware) that enable computing system 600 to perform foreign currency gain/loss analysis as described herein. Note that gain/loss analyzer 670 be one or many functional components. In one embodiment, gain/loss analyzer 670 is executed by processor 610 from instructions stored in memory 620.

Various operations or functions are described herein, which may be described or defined as software code, instructions, configuration, and/or data. The content may be directly executable (“object” or “executable” form), source code, or difference code (“delta” or “patch” code). The software content of the embodiments described herein may be provided via an article of manufacture with the content stored thereon, or via a method of operating a communication interface to send data via the communication interface. A machine readable medium may cause a machine to perform the functions or operations described, and includes any mechanism that provides (i.e., stores and/or transmits) information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein may be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A computer-implemented method, comprising:
obtaining a foreign currency exposure data element from a business system having multicurrency accounting information, the foreign currency exposure data element including a business entity, account identifier, and a summary balance for the identified account in a transaction currency of the business entity at a beginning of a time interval;
obtaining a second foreign currency exposure data element from the business system including the business entity, the account identifier, and a second summary balance for the identified account in the transaction currency, at an end of the time interval;
calculating an expected foreign currency gain/loss for the exposure data element in a reporting currency of the enterprise in which the business entity exists for the time interval, where calculating includes
computing a beginning foreign currency exposure in a functional currency of the business entity based on the summary balance of the exposure data element and an exchange rate for the transaction currency in relation to the functional currency at the beginning of the time interval;
computing an ending foreign currency exposure in the functional currency of the business entity based on the second summary balance of the second exposure data element and a second exchange rate for the transaction currency in relation to the functional currency at the end of the time interval;
computing a delta foreign currency exposure in the functional currency of the business entity based on a difference between the summary balance of the exposure data element and the second summary balance of the second exposure data element, and a delta exchange rate associated with the time interval for the transaction currency and the functional currency;
generating the expected foreign currency gain/loss in the functional currency of the business entity by combining the beginning foreign currency exposure and the delta foreign currency exposure to form an intermediate result, and taking the difference between the intermediate result and the ending foreign currency exposure; and
calculating the expected foreign currency gain/loss in the reporting currency of the enterprise by multiplying the expected foreign currency gain/loss in the functional currency of the business entity by a translation exchange rate between the functional currency of the business entity and the reporting currency of the enterprise at the end of the time interval; and
generating a report to indicate the calculated expected foreign currency gain/loss in the reporting currency by business entity.

2. The method of claim 1, wherein the multicurrency accounting information further comprises intercompany transaction accounting data, the foreign currency exposure data element and the second foreign currency exposure data element further including a trading partner identifier for the identified account, where the trading partner identifier is associated with a second business entity.

3. The method of claim 1, wherein the time interval comprises an accounting period.

4. The method of claim 1, further comprising:
obtaining third and fourth foreign currency exposure data elements from a second business system having multicurrency accounting information, the foreign currency exposure data elements including an account identifier, the third foreign currency exposure data element having a summary balance for the identified account in a transaction currency of the business entity at a beginning of a time interval, and the fourth foreign currency exposure data element having a summary balance for the identified account in the transaction currency of the business entity at an ending of the time interval; and
summing the calculated expected foreign currency gain/loss for the business entity for the account identified in the foreign currency exposure data element and the second foreign currency exposure data element of the first business system with the calculated expected foreign currency gain/loss for the account identified in the third and fourth foreign currency exposure data elements of the second business system.

5. The method of claim 4, wherein the different business systems identify the business entity by different business entity identifiers, and further comprising:
mapping the different business entity identifiers to each other as referencing the same business entity.

6. The method of claim 1, wherein calculating the expected foreign currency gain/loss further comprises:
obtaining the exchange rate for the transaction currency in relation to the functional currency at the beginning of the time interval, the second exchange rate for the transaction currency in relation to the functional currency at the end of the time interval, and the delta exchange rate;
wherein obtaining the exchange rates comprises one of or more of: receiving a specified exchange rate with the exposure data elements, receiving an exchange rate from a recognized electronic exchange rate source, providing a default exchange rate, or a combination of these.

7. The method of claim 1, further comprising:
summing the calculated expected foreign currency gain/loss for the identified account with expected foreign currency gain/loss for other accounts for the business entity to generate an expected foreign currency gain/loss at a business entity level.

8. The method of claim 7, further comprising:
receiving actual foreign currency gain/loss information for the business entity for the time interval as indicated in accounting records; and
comparing the calculated expected foreign currency gain/loss for the business entity to the actual foreign currency gain/loss for the business entity for the time interval;
wherein generating the report further comprises indicating the comparison of the calculated expected foreign currency gain/loss to the actual foreign currency gain/loss for the business entity.

9. The method of claim 7, further comprising:
receiving actual foreign currency gain/loss information for the business entity for the time interval as indicated in accounting records; and
receiving derivative instrument result information for the time interval by business entity;
wherein generating the report further comprises indicating derivative results based upon a change in value of the derivative instrument due solely to a change in spot foreign currency exchange rate for the time interval.

10. The method of claim 7, further comprising:
receiving actual foreign currency gain/loss information for the business entity for the time interval as indicated in accounting records; and
receiving derivative instrument result information for the time interval by business entity;
wherein generating the report further comprises indicating derivative results based upon a cost/benefit of the derivative instrument based upon market costs for the derivative instrument (spread), and any associated interest rate differentials (forward points) or option premiums for the time interval.

11. An article of manufacture comprising a machine-readable storage medium having content stored thereon to provide instructions to cause a machine to perform operations, including:
obtaining a foreign currency exposure data element from a business system having multicurrency accounting information, the foreign currency exposure data element including a business entity, account identifier, and a summary balance for the identified account in a transaction currency of the business entity at a beginning of a time interval;
obtaining a second foreign currency exposure data element from the business system, the second foreign currency exposure data element including the business entity, the account identifier, and a second summary balance for the identified account in the transaction currency, at an end of the time interval;
calculating an expected foreign currency gain/loss for the foreign currency exposure data element in a reporting currency of an enterprise in which the business entity exists for the time interval, where calculating includes
computing a beginning exposure in a functional currency of the business entity based on the summary balance of the foreign currency exposure data element and an exchange rate for the transaction currency in relation to the functional currency at the beginning of the time interval;
computing an ending exposure in the functional currency of the business entity based on the second summary balance of the second foreign currency exposure data element and a second exchange rate for the transaction currency in relation to the functional currency at the end of the time interval;
computing a delta exposure in the functional currency of the business entity based on a difference between the summary balance of the foreign currency exposure data element and the second summary balance of the second foreign currency exposure data element, and a delta exchange rate associated with the time interval for the transaction currency and the functional currency;
generating the expected foreign currency gain/loss in the functional currency of the business entity by combining the beginning exposure and the delta exposure to form an intermediate result, and taking the difference between the intermediate result and the ending exposure; and
calculating the expected foreign currency gain/loss in the reporting currency of the enterprise by multiplying the expected foreign currency gain/loss in the functional currency of the business entity by a translation exchange rate between the functional currency of the business entity and the reporting currency of the enterprise at the end of the time interval; and
generating a report to indicate the calculated expected foreign currency gain/loss in the reporting currency by business entity.

12. The article of manufacture of claim 11, wherein the content for calculating the expected foreign currency gain/loss further comprises content to provide instructions for
obtaining the exchange rate for the transaction currency in relation to the functional currency at the beginning of the time interval, the second exchange rate for the transaction currency in relation to the functional currency at the end of the time interval, and the delta exchange rate;
wherein obtaining the exchange rates comprises one of or more of: receiving a specified exchange rate with the exposure data elements, receiving an exchange rate from a recognized electronic exchange rate source, providing a default exchange rate, or a combination of these.

13. The article of manufacture of claim 11, further comprising content to provide instructions for
summing the calculated expected foreign currency gain/loss for the identified account with expected foreign currency gain/loss for other accounts for the business entity to generate an expected foreign currency gain/loss at a business entity level.

14. The article of manufacture of claim 13, further comprising content to provide instructions for
receiving actual foreign currency gain/loss information for the business entity for the time interval as indicated in accounting records; and
comparing the calculated expected foreign currency gain/loss for the business entity to the actual foreign currency gain/loss for the business entity for the time interval;
wherein generating the report further comprises indicating the comparison of the calculated expected foreign currency gain/loss to the actual foreign currency gain/loss for the business entity.

15. The article of manufacture of claim 13, further comprising content to provide instructions for
receiving actual foreign currency gain/loss information for the business entity for the time interval as indicated in accounting records; and
receiving derivative instrument result information for the time interval by business entity;
wherein generating the report further comprises indicating derivative results based upon a total cost/value of the derivative instrument.

16. A computer system comprising:
a memory storing instructions that define a foreign currency gain/loss analyzer having
a data collector to obtain multiple exposure foreign currency data elements from multicurrency enterprise resource planning systems (ERPs) or accounting systems, the exposure data elements including a business entity, and account identifier, where a first data element includes a first summary balance for the identified account in a transaction currency of the business entity at a beginning of a time interval, and second data element includes a second summary balance for the identified account in the transaction currency, at an end of the time interval;
a rate determiner to identify a beginning exchange rate for the transaction currency at the beginning of the time interval, an ending exchange rate for the transaction currency at the ending of the time interval, a delta exchange rate associated with the time interval for the transaction currency and a functional currency of an enterprise to which the business entity belongs, and a translation exchange rate between the functional currency and a reporting currency of the business entity at the end of the time interval;
an analysis engine to calculate an expected foreign currency gain/loss for the exposure data element in the reporting currency of the business entity for the time interval, the calculating including computing a beginning exposure in the functional currency of the business entity based on the first summary balance and the beginning exchange rate, computing an ending exposure in the functional currency of the business entity based on the second summary balance and the ending exchange rate, computing a delta exposure in the functional currency of the business entity based on a difference between the first and second summary balances and the delta exchange rate, calculating the expected foreign currency gain/loss in the reporting currency by multiplying the translation exchange rate by a difference between the ending exposure and the beginning exposure plus the delta exposure, and summing all results by business entity; and
a report engine to generate a foreign currency gain/loss report to indicate the calculated expected foreign currency gain/loss in the reporting currency by business entity; and
a processor to execute the instructions to implement the analyzer.

17. The computer system of claim 16, wherein the rate determiner determines the delta exchange rate as a one of a daily average, an endpoint average, or a weighted average.

18. The computer system of claim 16, wherein the computer system is part of a hosted application service provider.

19. A computer-implemented method, comprising:
obtaining accounting data from a business system having multicurrency accounting information, the accounting data having multiple rows of records, each record indicating a business entity, account identifier, currency, and account balance for the identified account;
extracting a first foreign currency exposure data element including a business entity and first summary balance for the business entity in a transaction currency at a beginning of a time interval, where the summary balance represents a calculated summary of all accounts by currency for the business entity;
extracting a second foreign currency exposure data element including the business entity and second summary balance for the business entity by currency at an end of the time interval;
calculating an expected foreign currency gain/loss for the time interval, the calculating including
computing a beginning foreign currency exposure in a functional currency of the business entity based on the first summary balance of the first exposure data element and an exchange rate for the transaction currency in relation to the functional currency at the beginning of the time interval;
computing an ending foreign currency exposure in the functional currency of the business entity based on the second summary balance of the second exposure data element and a second exchange rate for the transaction currency in relation to the functional currency at the end of the time interval;
computing a delta foreign currency exposure in the functional currency of the business entity based on a difference between the first summary balance of the first exposure data element and the second summary balance of the second exposure data element, and a delta exchange rate between the transaction currency and the functional currency for the time interval; and
generating the expected foreign currency gain/loss in the functional currency by combining the beginning exposure and the delta exposure to form an intermediate result, and taking a difference between the intermediate result and the ending exposure;
summing all results by business entity; and
generating a report to indicate the calculated expected foreign currency gain/loss.
